(19) United States
(12) Patent Application Publication
(10) Pub. No.: US 2022/0407103 A1
(43) Pub. Date: Dec. 22, 2022

(54) FUEL CELL STACK

(71) Applicant: TOYOTA BOSHOKU KABUSHIKI KAISHA, Aichi-ken (JP)

(72) Inventor: Satoshi KAWABE, Ichinomiya-shi (JP)

(73) Assignee: TOYOTA BOSHOKU KABUSHIKI KAISHA, Aichi-ken (JP)

(21) Appl. No.: 17/776,435

(22) PCT Filed: Nov. 27, 2020
(86) PCT No.: PCT/JP2020/044282

§ 371 Date: May 12, 2022

(30) Foreign Application Priority Data
Dec. 16, 2019 (JP) 2019-226251

(51) Int. Cl. H01M 8/2483

(52) U.S. Cl. CPC H01M 8/2483

(57) ABSTRACT

A fuel cell stack includes a cell stack body, a terminal plate, an end plate, and an insulating plate. The terminal plate is disposed adjacent to the cell stack body in a stacking direction. The terminal plate is configured to collect current. The end plate is disposed on a side of the terminal plate opposite from the cell stack body. The insulating plate is disposed between the terminal plate and the end plate. The insulating plate is made of an electrically insulating resin material. The insulating plate integrally holds the terminal plate and the end plate.

### TECHNICAL FIELD

The present disclosure relates to a fuel cell stack.

### BACKGROUND ART

Fuel cells include a fuel cell stack including a cell stack body in which cells are stacked (refer to, for example, Patent Literature 1). In the fuel cell stack disclosed in Patent Literature 1, end plates are respectively disposed at the opposite ends of the cell stack body in a stacking direction with terminal plates and insulators arranged between the end plates. Each insulator is made of an electrically insulating resin material. Coupling bars are disposed between the two end plates to couple the sides of the two end plates to each other. The end plates and the coupling bars are coupled to each other by bolts. The two end plates coupled by the coupling bars hold the insulators, the terminal plates, and the cell stack body.

### CITATION LIST

### Patent Literature

Patent Literature 1: Japanese Laid-Open Patent Publication No. 2017-4880

### SUMMARY OF INVENTION

### Technical Problem

In such a fuel cell stack, the end plates are potentially deformed by tightening load of the bolts. Thus, when the thicknesses of the end plates are increased to limit the deformation of the end plates, increases occur in the weights of the end plates.

It is an objective of the present disclosure to provide a fuel cell stack capable of limiting the deformation of end plates while limiting increases in the thicknesses of the end plates.

### Solution to Problem

A fuel cell stack that achieves the above-described objective includes a cell stack body in which cells are stacked, a terminal plate disposed adjacent to the cell stack body in a stacking direction, the terminal plate being configured to collect current, an end plate disposed on a side of the terminal plate opposite from the cell stack body, and an insulating plate disposed between the terminal plate and the end plate, the insulating plate being made of an electrically insulating resin material. The insulating plate integrally holds the terminal plate and the end plate.

In this structure, since the insulating plate integrally holds the terminal plate and the end plate, the rigidity of the end plate increases as compared with a structure in which the end plate is separate from the insulating plate and the terminal plate. This limits the deformation of the end plate while limiting an increase in the thickness of the end plate.

### BRIEF DESCRIPTION OF DRAWINGS

FIG. 1 is a perspective view showing a fuel cell stack according to an embodiment.

FIG. 2 is a cross-sectional view taken along line 2-2 in FIG. 1.

FIG. 3 is a cross-sectional view showing a fuel cell stack according to a modification.

FIG. 4 is a cross-sectional view showing a fuel cell stack according to another modification.

### DESCRIPTION OF EMBODIMENTS

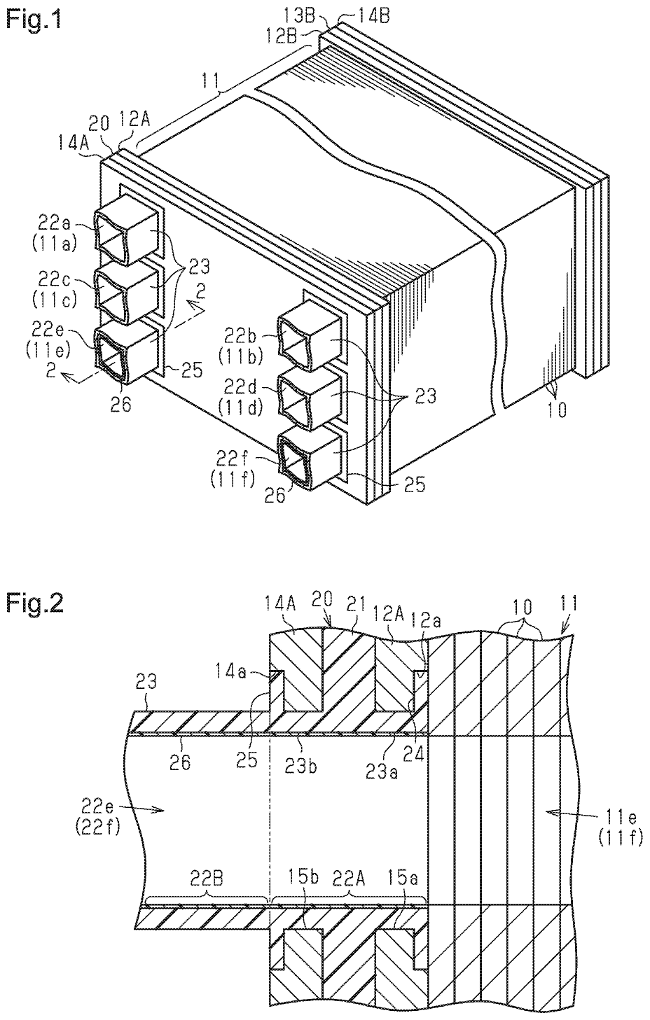

An embodiment will now be described with reference to FIGS. 1 and 2.

As shown in FIGS. 1 and 2, the fuel cell stack includes a cell stack body 11 in which plate-shaped cells 10 are stacked in a thickness direction.

An end plate 14A is disposed at one end of the cell stack body 11 in a stacking direction with a terminal plate 12A and an insulating plate 20 arranged between the cell stack body 11 and the end plate 14A. The terminal plate 12A collects current, and the insulating plate 20 performs insulating. An end plate 14B is disposed at the other one end of the cell stack body 11 in the stacking direction with a terminal plate 12B and an insulating plate 13B arranged between the cell stack body 11 and the end plate 14B. The terminal plate 12B collects current, and the insulating plate 13B performs insulating. In the following description, the stacking direction of the cell stack body 11 is simply referred to as the stacking direction.

As shown in FIG. 1, the cell stack body 11 includes three passages 11a, 11b, 11c through which cathode gas (e.g., oxygen gas in the air), anode gas (e.g., hydrogen gas), and cooling medium (e.g., coolant) are respectively supplied to each cell 10. The cell stack body 11 further includes three passages 11f, 11e, 11d through which the cathode gas, the anode gas, and the cooling medium that have been used to generate power in each cell 10 are respectively discharged.

Referring to FIG. 2, the terminal plate 12A includes six quadrilateral first through-holes 15a that extend through the terminal plate 12A in the thickness direction. Cathode gas, anode gas, and cooling medium flow between the passages 11a to 11f of the cell stack body 11 and the first through-holes 15a. In the following description, cathode gas and anode gas are collectively referred to as reactant gas.

The end plate 14A includes six second through-holes 15b that extend through the end plate 14A in the thickness direction and are located in correspondence with the first through-holes 15a. Reactant gas and cooling medium flow through the second through-holes 15b. In the same manner as the first through-holes 15a, the second through-holes 15b are quadrilateral.

The terminal plate 12B and the end plate 14B do not include the through-holes 15a, 15b.

The structure of the insulating plate 20 will now be described. In the following description, the side of the plates 12A, 20, 14A that is closer to the cell stack body 11 is referred to as the inner side, and the side of the plates 12A, 20, 14A that is farther from the cell stack body 11 is referred to as the outer side.

As shown in FIGS. 1 and 2, the insulating plate 20 includes a plate body 21 and six passage portions 22a to 22f. The plate body 21 is held by the terminal plate 12A and the end plate 14A. The passage portions 22a to 22f cover the wall surfaces of the through-holes 15a, 15b. Further, reactant gas and cooling medium flow through the passage portions 22a to 22f.

As shown in FIG. 1, each of the passage portions 22a to 22f includes a peripheral wall 23. Each peripheral wall 23 has a quadrilateral annular cross-sectional shape.

FIG. 2 shows the cross-sectional structure of the passage portion 22e, through which the anode gas that has been used to generate power in each cell 10 is discharged. The passage portion 22f, through which the cathode gas that has been used to generate power in each cell 10 is discharged, has the same cross-sectional structure as the passage portion 22e.

Referring to FIG. 2, each peripheral wall 23 is formed integrally with the plate body 21 using an electrically insulating resin material. It is preferred that examples of the electrically insulating resin material include polyphenylene sulfide, polyamide, polypropylene, and polyethylene.

The peripheral wall 23 of each of the passage portions 22a to 22f includes a first holder 23a and a second holder 23b. The first holder 23a protrudes inward of the first through-hole 15a and holds the terminal plate 12A. The second holder 23b protrudes inward of the second through-hole 15b and holds the end plate 14A.

The first holder 23a includes an annular wall that covers the wall surface of the first through-hole 15a and has a quadrilateral annular cross-sectional shape. A first flange 24 that protrudes toward an outer peripheral side is formed integrally with the first holder 23a. The first flange 24 is accommodated in a recess 12a of the terminal plate 12A. The inner surface of the first flange 24 is flush with the inner surface of the terminal plate 12A.

The second holder 23b includes an annular wall that covers the wall surface of the second through-hole 15b and has a quadrilateral annular cross-sectional shape. A second flange 25 that protrudes toward the outer peripheral side is formed integrally with the second holder 23b. The second flange 25 is accommodated in a recess 14a of the end plate 14A. The outer surface of the second flange 25 is flush with the outer surface of the end plate 14A.

The first flange 24 and the second flange 25 sandwich the terminal plate 12A and the end plate 14A so that the terminal plate 12A and the end plate 14A are integrally held by the insulating plate 20.

The peripheral wall 23 extends outward from the outer surface of the end plate 14A. In the following description, the portion of each of the passage portions 22a to 22f located inward from the outer surface of the end plate 14A is referred to as the inner passage portion 22A. Further, the portion of each of the passage portions 22a to 22f located outward from the outer surface of the end plate 14A is referred to as the outer passage portion 22B.

The inner surface of the inner passage portion 22A is flush with the inner surface of the outer passage portion 22B.

The entire inner surface of the peripheral wall 23 of the passage portion 22e (22f) includes a hydrophilic portion 26. The hydrophilic portion 26 is made of a resin material that is more hydrophilic than the resin material of the peripheral wall 23. That is, the hydrophilic portion 26 is disposed on the inner passage portion 22A and the outer passage portion 22B. It is preferred that the hydrophilic resin material be, for example, polyolefin-based resin material.

The inner surface of the inner passage portion 22A in the passage portion 22e (22f), i.e., the inner surface of the hydrophilic portion 26 is flush with the inner surface of the passage 11e (11f) of the cell stack body 11.

The hydrophilic portion 26 is not disposed on the inner surfaces of the peripheral walls 23 of the passage portions 22a, 22b, through which reactant gas is supplied to each cell 10, the passage portion 22c, through which cooling medium is supplied to each cell 10, and the passage portion 22d, through which cooling medium is discharged.

The method for molding the insulating plate 20 will now be described.

The insulating plate 20 is formed through insert-molding. In the insert-molding, the terminal plate 12A and the end plate 14A are inserted into a mold and then molten resin is injected into the cavity formed by the mold and the plates 12A, 14A. This causes the insulating plate 20 to be molded integrally with the terminal plate 12A and the end plate 14A.

The hydrophilic portion 26 is formed through two-color molding. In the two-color molding, an integrally-molded component of the insulating plate 20, the terminal plate 12A, and the end plate 14A is inserted into a mold and then molten resin is injected into the cavity formed by the mold and the peripheral wall 23. This causes the hydrophilic portion 26 to be molded integrally with the peripheral wall 23.

The advantages of the present embodiment will now be described.

(1) The insulating plate 20 integrally holds the terminal plate 12A and the end plate 14A.

In this structure, since the insulating plate 20 integrally holds the terminal plate 12A and the end plate 14A, the rigidity of the end plate 14A increases as compared with a structure in which the end plate 14A is separate from the insulating plate 20 and the terminal plate 12A. This limits the deformation of the end plate 14A while limiting an increase in the thickness of the end plate 14A.

(2) The insulating plate 20 includes the first holder 23a and the second holder 23b. The first holder 23a protrudes inward of the first through-hole 15a of the terminal plate 12A and holds the terminal plate 12A. The second holder 23b protrudes inward of the second through-hole 15b of the end plate 14A and holds the end plate 14A.

In such a structure, the first holder 23a and the second holder 23b that integrally hold the terminal plate 12A and the end plate 14A do not protrude from the outer surfaces of the terminal plate 12A and the end plate 14A. This limits an increase in the size of the fuel cell stack.

(3) The first holder 23a includes the annular wall that covers the wall surface of the first through-hole 15a. The second holder 23b includes the annular wall that covers the wall surface of the second through-hole 15b. The first holder 23a and the second holder 23b define a discharge passage for reactant gas.

In such a structure, the first holder 23a and the second holder 23b define the passage portions 22a to 22f for reactant gas or cooling medium. Thus, as compared with a structure in which holders are disposed in addition to the passage portions 22a to 22f, the structure of the terminal plate 12A, the insulating plate 20, and the end plate 14A is simplified.

(4) The first flange 24 that protrudes toward the outer peripheral side is formed integrally with the first holder 23a. The second flange 25 that protrudes toward the outer peripheral side is formed integrally with the second holder 23b. The first flange 24 and the second flange 25 sandwich the terminal plate 12A and the end plate 14A so that the terminal plate 12A and the end plate 14A are integrally held by the insulating plate 20.

In such a structure, the first flange 24 and the second flange 25 sandwich the terminal plate 12A and the end plate 14A so that the insulating plate 20 holds the terminal plate 12A and the end plate 14A more strongly.

(5) The passage portions 22e, 22f each include the peripheral wall 23 and the hydrophilic portion 26. The peripheral wall 23 is made of an electrically insulating resin material. The hydrophilic portion 26 is located on the inner surface of the peripheral wall 23 and made of a resin material that is more hydrophilic than the resin material of the peripheral wall 23.

In such a structure, the peripheral wall 23 of each of the passage portions 22e, 22f includes the hydrophilic portion 26. Thus, the contact angles formed by the droplets of generated water collected on the inner surface of the hydrophilic portion 26 and by the inner surface are smaller than the contact angles formed by the droplets of generated water collected on the inner surfaces of the peripheral walls that do not include the hydrophilic portion 26. That is, the contact area of the droplets of generated water and the inner surface of each of the passage portions 22e, 22f increases as compared with the peripheral walls that do not include the hydrophilic portion 26. This shortens the distances between the droplets of generated water that approach each other. Thus, the droplets of the generated water in the passage portions 22e, 22f are easily connected to each other. As a result, the generated water that has been enlarged by the connection of the droplets is effectively affected by, for example, the weight of the water or the difference in pressure between the inside and outside of the cell stack body 11. This allows the generated water to be easily discharged out of the passage portions 22e, 22f.

(6) The fuel cell stack includes the outer passage portion 22B that is connected to the inner passage portion 22A and extended outward of the end plate 14A. The inner surface of the inner passage portion 22A is flush with the inner surface of the outer passage portion 22B.

In such a structure, there is no step between the inner surface of the outer passage portion 22B and the inner surface of the inner passage portion 22A. This limits situations in which generated water remains in the inner passage portion 22A. Thus, generated water is smoothly discharged to the outside.

(7) The outer passage portion 22B includes the peripheral wall 23 and the hydrophilic portion 26 and is molded integrally with the inner passage portion 22A.

In such a structure, the inner surface of the inner passage portion 22A is easily made flush with the inner surface of the outer passage portion 22B. Further, as compared with when, for example, the outer passage portion 22B that is separate from the inner passage portion 22A is coupled to the inner passage portion 22A, the number of components and the number of coupling steps in the fuel cell stack are reduced.

### MODIFICATIONS

The above-described embodiments may be modified as follows. The present embodiment and the following modifications can be combined as long as they remain technically consistent with each other.

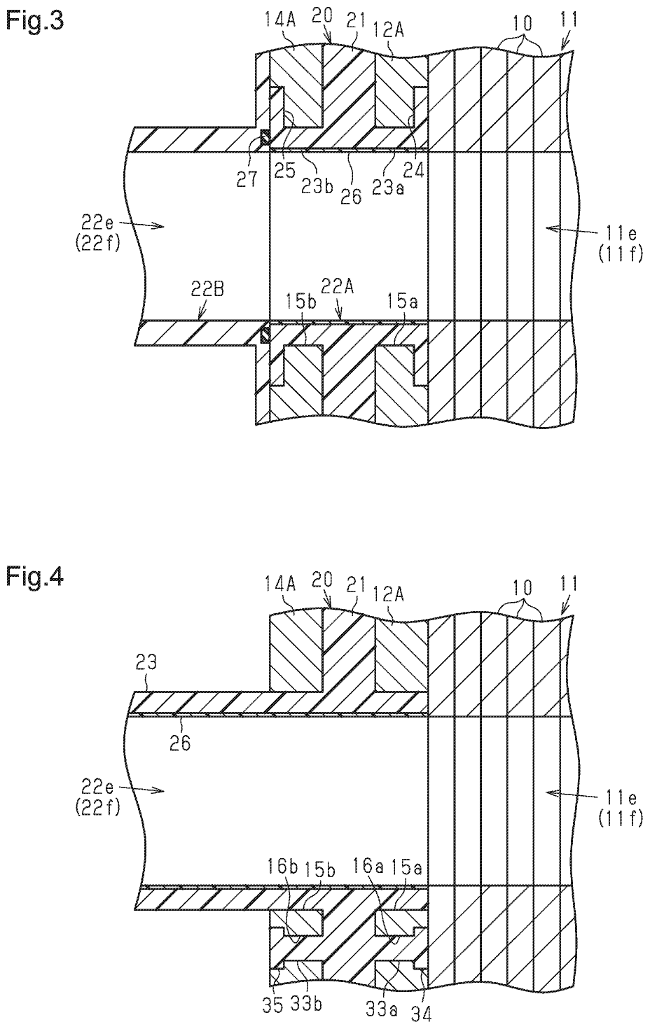

As shown in FIG. 3, the outer passage portion 22B that is separate from the inner passage portion 22A may be connected to the inner passage portion 22A using a seal member 27. In this case, it is preferred that the inner surface of the hydrophilic portion 26 of the inner passage portion 22A be flush with the inner surface of the outer passage portion 22B.

As shown in FIG. 4, the first flange 24 and the second flange 25 may be omitted. In this case, as shown in FIG. 4, a first holder 33a and a second holder 33b that do not define a passage portion may be disposed. The terminal plate 12A includes a first through-hole 16a on the outer peripheral side of the first through-hole 15a. The end plate 14A includes a second through-hole 16b on the outer peripheral side of the second through-hole 15b. The first holder 33a has a columnar shape and fills the first through-hole 16a. The second holder 33b has a columnar shape and fills the second through-hole 16b. A first flange 34 that protrudes toward the outer peripheral side is formed integrally with the first holder 33a. A second flange 35 that protrudes toward the outer peripheral side is formed integrally with the second holder 33b. The first flange 34 and the second flange 35 sandwich the terminal plate 12A and the end plate 14A so that the terminal plate 12A and the end plate 14A are integrally held by the insulating plate 20.

The first holder and the second holder that integrally hold the terminal plate 12A and the end plate 14A do not have to protrude inward of the through-holes 15a, 15b. Instead, the first holder and the second holder may protrude from the outer surfaces of the terminal plate 12A and the end plate 14A and surround the outer edges of the plates 12A, 14A so as to integrally hold the plates 12A, 14A.

The cross-sectional shape of the peripheral wall 23 is not limited to a quadrilateral annular shape. Likewise, the cross-sectional shapes of the annular wall of the first holder 23a and the annular wall of the second holder 23b are not limited to a quadrilateral annular shape. That is, the cross-sectional shapes of the peripheral wall 23, the annular wall of the first holder 23a, and the annular wall of the second holder 23b simply need to be annular. The term “annular” as used in this description may refer to any structure that forms a loop, or a continuous shape with no ends. “Annular” shapes include but are not limited to a circular shape, an elliptic shape, and a polygonal shape with sharp or rounded corners.

### REFERENCE SIGNS LIST

10) Cell

11) Cell Stack Body

11a to 11f) Passage

12A, 12B) Terminal Plate

12a) Recess

13B, 20) Insulating Plate

14A, 14B) End Plate

14a) Recess

15a, 16a) First Through-Hole

15b, 16b) Second Through-Hole

21) Plate Body

22a to 22f) Passage Portion

22A) Inner Passage Portion

22B) Outer Passage Portion

23) Peripheral Wall

23a, 33a) First Holder

23b, 33b) Second Holder

24, 34) First Flange

25, 35) Second Flange

26) Hydrophilic Portion

27) Seal Member

1.-4. (canceled)

5. A fuel cell stack, comprising:
a cell stack body in which cells are stacked;
a terminal plate disposed adjacent to the cell stack body in a stacking direction, the terminal plate being configured to collect current;
an end plate disposed on a side of the terminal plate opposite from the cell stack body; and
an insulating plate disposed between the terminal plate and the end plate, the insulating plate being made of an electrically insulating resin material, wherein
the insulating plate integrally holds the terminal plate and the end plate,
the terminal plate includes first through-holes,
the end plate includes second through-holes,
the insulating plate includes passage portions each including a peripheral wall,
the peripheral wall of each of the passage portions includes:
a first holder that holds the terminal plate, the first holder including an annular wall that covers a wall surface of a corresponding one of the first through-holes; and
a second holder that holds the end plate, the second holder including an annular wall that covers a wall surface of a corresponding one of the second through-holes,
the passage portions include a passage portion through which reactant gas is discharged, and
a hydrophilic portion is disposed on an inner surface of the peripheral wall of the passage portion through which reactant gas is discharged, the hydrophilic portion being made of a resin material that is more hydrophilic than the resin material of the peripheral wall.

6. The fuel cell stack according to claim 5, wherein
a first flange that protrudes toward an outer peripheral side is formed integrally with each of the first holders,
a second flange that protrudes toward the outer peripheral side is formed integrally with each of the second holders, and
the first flanges and the second flanges sandwich the terminal plate and the end plate so that the terminal plate and the end plate are integrally held by the insulating plate.
